(19) United States
(12) Patent Application Publication
(10) Pub. No.: US 2002/0022967 A1
(43) Pub. Date: Feb. 21, 2002

(54) Goods delivery method, online shopping method, online shopping system, server, and vender server

(75) Inventor: Akira Ohkado, Yokohama-shi (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 09/843,501

(22) Filed: Apr. 26, 2001

(30) Foreign Application Priority Data
Aug. 18, 2000 (JP) 2000-168898

(51) Int. Cl. G06F 17/60

(52) U.S. Cl. 705/1

(57) ABSTRACT

[Object]

It is one object of the present invention to provide a goods delivery method for improving the anonymity of a customer, and an online shopping method, an online shopping system, a server, and a shop server therefor.

[Constitution]

A customer 3 orders an article from a shop 2 by using an anonymous ID. The shop 2 attaches, to the article, a slip 100 on which not personal information for the customer 3 is printed, and dispatches the article to an anonymous service provider 1. Thereafter, the anonymous service provider 1 replaces the slip 100 with a slip 200 on which the name and address of the customer 3 is printed, and delivers the article to the customer 3.

### DETAILED DESCRIPTION OF THE INVENTION

1. Field of the Invention

The present invention relates to a goods delivery method for delivering an article that is ordered via a network, and an online shopping method, an online shopping system, a server, and a vender server therefor.

2. Background Art

Electronic commerce (EC), which essentially is the online sale, procurement and trading of goods over the Internet, has recently drawn great attention. For online shopping, first, users access the home pages of virtual, electronic shops whereat they may browse through electronic catalogs, scan pages bearing product illustrations and accompanying descriptions, and select articles to purchase. Then, when a user clicks on a “buy” or another button reflecting his or her intention to purchase one or more items, a current page is exchanged for one for the entry of a delivery address and other, required personal information. All that is normally required of the user, such as his or her name and address and the preferred payment method, is input and by clicking on a button to transmit the data to the virtual shop, the purchase procedures have been completed.

For online shopping, when searching through the goods offered by a virtual shop, a customer can not, of course, actually see and touch articles, as when shopping in an actual store, and even an electronic catalog is inferior to an ordinary paper catalog. However, when a customer shops on line, the customer can use a search function to examine an enormous amount of article information, which makes it easy for the customer to select a desired article. Further, the user takes the advantage of the latest available shopping information, without having to leave his or her home or office.

For online vendors, expensive equipment and furnishings for stores need not be purchased, and although a wide range of customers can be targeted, regardless of their physical location, the labor and the expenses involved in the delivery of catalogs can be eliminated.

As is described above, online shopping is a form of electronic commerce that provides many benefits, both for customers and for vendors.

With online shopping, however, ensuring the anonymity of a customer is difficult.

For example, when customers use online shopping transactions to purchase goods on the Internet, credit cards, because of the convenience they offer, are the most frequently employed means for paying for the goods (settling the accounts). But when a credit card is used, a customer must provide a shop his or her credit card number, and there is an especially high probability that the credit card number will be illegally employed. Therefore, prepaid electronic money is employed by one part of shops, so that the credit card number of the customer need not be reported to the shops. By the employment of the electronic money, the customer can maintain his or her anonymity relative to the shop as in when the customer pays the article by cash.

[Problems to be Solved by the Invention]

As is described above, while means for maintaining the anonymity of customers when shopping on line has been employed for settling accounts, still, a problem exists in that shops can obtain personal information concerning customers when they deliver articles that have been purchased.

That is, when a customer desires to obtain from a shop, through online shopping, a substantial article, unlike the electronic data that is available on line, the customer must furnish the shop personal information, such as his or her name, address and telephone number, when requesting delivery of the article.

Even when a customer furnishes a shop only such personal information, including an address, as is required for the delivery of an article, the shop could use the thus acquired personal information for other purposes. For example, a shop could use a customer's address to send direct mail, or it could accumulate data produced by a customer's purchases and use it for market research. Further, a vender could maliciously sell personal information to another shop, and as a result a customer could receive certain unwanted communications and have unpleasant experiences.

In addition, when a customer makes a purchase that he or she would prefer no one else knew about, the shop, at the least, would know what the customer purchased. And furthermore, since the name, the address and the telephone number of a customer, and the name of the item purchased and the shop at which it was purchased are written on the delivery slip that accompanies a package, this personal information is exposed and readily available to the delivery company that transports the package from the shop to the customer, and especially to the delivery man who makes the actual delivery.

There are verified instances of the occurrence of such online shopping problems, which would not have arisen for the customers who have bought and received of the same items at actual retail establishments, and paid for their purchases in cash, so there was no need to furnish such personal information as their names, addresses, telephone numbers and credit card numbers to the vendors. As is described above, online shopping still has some room for improvement in ensuring the anonymity of customers during the delivery of purchases.

To resolve the above technical problems, it is one object of the present invention to provide a goods delivery method that provides improved anonymity for a customer, and an online shopping method, an online shopping system, a server and a vender server therefor.

### SUMMARY OF THE INVENTION

To achieve the above object, according to one preferred embodiment of the present invention, a goods delivery method comprises the steps of: (a) the shop obtaining article information that specifies the article to be delivered to the customer and an anonymous code that specifies the delivery address of the customer; (b) the shop transmitting, to the service provider, the article that corresponds to the article information so as to correlate anonymous code with the article; (c) the service provider obtaining the delivery address for the customer based on the anonymous code; and (d) the service provider delivering the article to the customer based on the delivery address obtained at the step (c).

As is described above, since the shop employs only the anonymous code when transferring the article to the service provider, the acquisition by the shop of personal information relating to the customer can be prevented. The anonymous code representing the delivery address of the customer must remain “anonymous”; the shop can have no direct knowledge of the delivery address of the customer. As is indicated at step (c), only the service provider can designate the delivery address of the customer based on the anonymous code.

Further, in accordance with another preferred embodiment of the present invention a goods delivery method comprises the steps of: (a) from a shop that obtains article information for specifying an article to be delivered to the customer and anonymous code for specifying a delivery address for the customer, receiving an article that corresponds to the article information correlated with the anonymous code; (b) employing the anonymous code to obtain the delivery distribution for the customer; and (c) transporting the article to the customer based on the delivery address obtained at the step (b).

A service provider may issue an anonymous code to a customer via a network, or the customer may prepare an anonymous code and transmit it to a service provider for registration. Thereafter, when the customer orders an article from a shop, he or she supplies the anonymous code to the shop.

When a customer places an order with a shop but does not supply an anonymous code, the shop can obtain an anonymous code from a service provider and transmit it to the customer. Thereafter, when the customer receives the anonymous code, he or she registers it and his or her delivery address with the service provider.

According to yet another preferred embodiment of the present invention, the service provider can be a product delivery service provider. That is, a package delivery service provider, such as the Ministry of Post and Telecommunications or a delivery company that handles packages, can serve as the service provider described above.

The present invention is not limited to these arrangements, and can be implemented when a service provider has a tie-in with a package delivery service provider, such as the Ministry of Post and Telecommunications or a delivery company, or entrusts a package delivery service provider with the responsibility for making a delivery.

For an online shopping method in accordance with the one form of the preferred embodiment of the present invention, a shop receives, via a network, an order for an article and an anonymous code from a customer, and thereafter transfers the article to a third party. The third party, in this case, is a person or entity that maintains records of anonymous codes and personal customer information, such as names and addresses, and that can deliver articles to customers based on the personal customer information stored in its files.

Once an article is transferred to the third party, the third party retrieves the name and the address of the customer and delivers the article.

Placing an order for an article and supplying an anonymous code need not always be performed at the same time, however, and can be performed at some arbitrary, agreed upon time before the article is delivered.

According to the online shopping method, electronic money, transmitted via a network, is employed by a customer to pay for an article ordered from a shop. As a result, customer anonymity is also ensured when a customer makes a payment.

An online shopping system according to the present invention comprises: a server at a shop; a terminal belonging to a customer; and a server at a service provider that is connected to a network and that is used to store personal information concerning of the customer and a correlated anonymous code provided for the customer, wherein the customer employs the terminal to place an order for an article and to supply the anonymous code to the server at the shop, wherein the shop attaches the anonymous code to the article that is ordered, and transfers the article to the service provider, and wherein the service provider employs its server to output the personal information concerning the customer that is correlated with the anonymous code attached to the article, and to thereafter attach the personal information to the article and deliver the article to the customer. Since, as is described above, for online shopping a customer supplies only an anonymous code to a shop, the shop is prevented from acquiring personal information concerning the customer. Further, since a service provider can thereafter use the anonymous code to recover personal customer information, such a name and an address, an article can be delivered as desired.

Here, personal customer information is information, e.g., a name, an address and a telephone number, that a shop could use to identify a customer, and an anonymous code, which consists of numerals, characters or signs and does not include any personal information, provides means to prevent the shop from identifying the customer. The online shopping anonymity provided by this invention can be set at an arbitrary level; in some cases, coding representing an area (a prefecture, a city, etc.) in which a customer resides, or coding representing the birthday of the customer can be included in the anonymous code.

To transfer an article to a service provider, a shop attaches to the article a first slip on which an anonymous code is printed, and then delivers the article to the service provider. The service provider then replaces the first slip on the article with a second slip on which the personal information for the customer is printed, and delivers the article to the customer. Since the first slip is replaced by the service provider, the shop can not acquire any personal customer information, and the anonymity of the customer can be maintained. Thus, this system is easily implemented simply by replacing the slips.

A server according to the present invention comprises: information storage means, for storing an anonymous code correlated with delivery address information for a customer; anonymous code input means, for inputting an anonymous code accompanying an article; and personal information output means, for examining the information storage means to recover and output the delivery address information for the customer that is correlated with the anonymous code. The server can further comprise code generation means for generating anonymous codes, and can therefore function as a service provider for an online shopping server.

The information storage means deletes an anonymous code after a predetermined period of time has elapsed, or after the anonymous code has been used once. Thus, an anonymous code deleted from the storage means can be reused.

The server in accordance with the present invention may further comprise: solvency confirmation means, for confirming the solvency of a customer; and payment proxy means, for, when the solvency of the customer has been confirmed by the solvency confirmation means, remitting the price of an article to a shop. Thus the service provider, by acting as a payment proxy and remitting the price of the article to the shop, contributes to the maintenance of the anonymity of the customer relative to the shop.

According to the preferable embodiment of the present invention, a shop server, for receiving from a customer an order for an article and an anonymous code, and for effecting the delivery of the article to the customer via a third party that manages the anonymous code and correlated personal customer information, comprises: an order acceptance unit, for accepting an order placed by the customer via a network; an anonymous code inquiry unit, for querying the third party via the network to determine the validity of the anonymous code supplied by the customer; an a slip output unit, for, when the validity of the anonymous code is confirmed by the third party, printing the anonymous code on a slip to be attached to the article, and outputting the slip.

In yet another form of preferred embodiment of the present invention, a service provider server can comprise: anonymous code display means, for displaying information for an anonymous code; and personal information display means for displaying personal information correlated with the anonymous code, thereby enabling a service provider to deliver an article based on the personal information displayed on the screen of the personal information display means. This arrangement is effective when, for example, a bar code is employed as an anonymous code and the information that is displayed based on the bar code is converted by the anonymous code display means and the personal information display means. When the service provider accepts an article from a shop, the anonymous code is displayed by the anonymous code display means, and when the service provider is preparing to deliver the article to the customer, the personal information for a customer can be retrieved and displayed on the personal information display means.

### Preferred Embodiments

The present invention will now be described in detail during the course of an explanation given, for a first to a fifth embodiment, while referring to the accompanying drawings.

### First Embodiment

FIG. 1 is a diagram for explaining the configuration of an online shopping system according to the embodiments of the present invention. In FIG. 1, an anonymous service provider 1, which is the nucleus of this system, is a delivery service provider, such as the Ministry of Post and Telecommunications or a delivery company, for handling and delivering packages, or a service provider that has a tie-in with such organizations. A shop 2, which is an order receiver and a vender, enters into a membership contract with the anonymous service provider 1, and is provided a unique shop identification number. A customer 3 is a person who places purchase orders for articles, and an electronic money accounting organization 4 is an entity that engages in monetary transactions with the shop 2 and that issues the electronic money the customer 3 uses when purchasing goods from the shop 2. A network 5 is, for example, the Internet, to which a server 11 of the anonymous service provider 1, a web server 21 of the shop 2 and a terminal 31 of the customer 3 are connected.

This system corresponds to the conventional system in that it provides for the delivery, to the customer 3, of an article the customer 3 ordered from the shop 2. However, for the transaction between the customer 3 and the shop 2, personal information for the customer 3 is not employed; instead, an anonymous ID is employed, which is provided as an anonymous code by the anonymous service provider 1, which acts as a third party. An article ordered by the customer 3 is transferred from the shop 2 to the service provider 1, and is then delivered by the service provider 1 to the customer 3. Further, the entries on a slip attached to the article differ between the time that the shop 2 transfers the article to the service provider 1 and the time that the service provider 1 delivers the article to the customer 3.

At the shop 2, the web server 21 opens to the public on the network 5 a homepage for online shopping. As part of the homepage there is an “electronic catalog” page whereon product illustrations and accompanying descriptions are provided that a customer 3 can scan to select an article to purchase, and a page bearing a “purchase” button, etc., the customer 3 can use to place a purchase order.

The shop 2 further comprises: an order receiving/accounting system 22 that serves as an order receiver and an anonymous code inquiry unit, for accepting purchase orders placed by customers 3 through the web server 21 and for performing required procedures for the settlement of accounts; a stock management system 23, for managing articles that are carried in stock; a dispatching system 24, for managing deliveries; an article DB (database) 25, in which data are stored concerning articles that are carried in stock; and an order DB 26, in which article order data are stored.

The terminal 31 of the customer 3 is, for example, a PC equipped with software, such as a browser 32 and a number request program 33. The browser 32 is used to browse a display of a member page of the anonymous service provider 1 and of the homepage of the shop 2, and can display on a screen a variety of information that is received. Also provided for the terminal 31 are input means, such as a pointing device or a keyboard, for the input of information and an amount of money. The number request program 33 submits requests to the number generation system of the anonymous service provider 1, which will be described later, for the generation of anonymous IDs. A clip board 34, a software program, is used to temporarily hold data when a cut-and-paste or a copy-and-paste procedure is performed.

The accounting organization 4 is connected to the shop 2 via a virtual private network (VPN) or a dedicated line, and includes an accounting system 41, for settling an account upon the receipt of a request from the order receiving/accounting system 22, and an electronic money DB 42, in which information concerning the issue of electronic money and other data is stored.

The customer 3 must register with the anonymous service provider 1 before service is provided. For this purpose, the server 11 of the anonymous service provider 1 includes a member management system 12, which manages data entered for registered members; a member DB (information storage means) 13, in which data for registered members are stored; and a number generation system (code generation means) 14, for generating an anonymous ID upon the receipt of a request from a registered member.

FIG. 2A is a member information table T1 that is stored in the member DB 13. A membership number is provided for each registered member, and the membership number and corresponding personal information are stored in the member information table T1. The personal information that is stored for each member includes the name, the postal code, the address, the telephone number, and the password of the member.

As is described above, the number generation system 14 generates an anonymous ID upon the receipt of a request from a registered member, and the anonymous ID is then stored in the member DB 13. FIG. 2B is an ID information table T2 stored in the member DB 13. The ID information table T2 includes, but is not limited to, anonymous IDs that have been generated, the generation dates for the anonymous IDs, the membership numbers of members who requested the generation of anonymous IDs, the employment status of the anonymous IDs, the shop membership numbers input as sources when anonymous IDs are used for the delivery of articles, the slip numbers used for deliveries, and the delivery completion dates.

It is preferable that a random sequence of alphanumeric characters, for example, be used for anonymous IDs, so that a customer 3 can not be identified, or so that personal information, such as the name, the address and the telephone number of the customer 3, can not be analogized. Further, to prevent illegal use, it is preferable that a random sequence be employed, so that an anonymous ID can not be analogous to another.

Further, an anonymous ID that is generated by the number generation system 14 is valid only for a predetermined period of time or can be used only a predetermined number of times. In this embodiment, an anonymous ID can be used only one time, and after it has been used once (for example, after a predetermined period of time has elapsed since an article was delivered), the anonymous ID is deleted from the ID information table T2 in the membership DB 13. An anonymous ID that has not been used for a predetermined period of time (e.g., 24 hours) is also deleted from the ID information table T2.

The member information table T1 and the ID information table T2 are provided separately, but can be integrally formed. However, while taking into account the subject of the system in this embodiment, i.e., the provision of anonymity for a customer 3, it is preferable that the member information table T1 and the information table T2 be provided separately, as is described above.

The member information table T1 and the ID information table T2 represent a logical information form. Neither of these tables, however, is limited to the above described form, and can be provided, as needed, as a set consisting of a plurality of tables.

The anonymous service provider 1 further includes a delivery management system (personal information output means) 15, for delivering, to a registered member, an article that is received from the shop 2; and a delivery DB 16, in which data concerning deliveries are stored.

As previously described above, with this system of the present invention, the contents of a slip attached to an article differ between the time that the shop 2 transfers an article ordered by a customer 3 to the anonymous service provider 1, and when the anonymous service provider 1 delivers the article to the customer 3. FIG. 3 is a diagram showing a slip 100, a first slip that is used when the shop 2 transfers an article ordered by a customer 3 to the anonymous service provider 1. The slip 100 includes a column 101, in which the anonymous ID generated by the number generation system 14 is printed; a bar code column 102, in which a bar code representing the anonymous ID is printed; and an article name column 103. As is shown in FIG. 3, the only customer 3 identity information on a slip 100 is an anonymous ID. The membership shop number of the shop 2 can also be added to the slip 100 as a sender.

FIG. 4 is a diagram showing a slip 200, which is a second and delivery slip used when the anonymous service provider 1 delivers to a customer 3 an article received from the shop 2. The slip 200 includes a column 201 in which personal information, such as the name, the address and the telephone number of the customer 3, is printed; a sender column 202; a bar code column 203, in which is included information, such as a slip number, required for the delivery of the article to the customer 3; and an article name column 204.

The sender column 202 is required when an ordinary delivery slip instead of a special anonymous slip is used as the slip 100. If a special anonymous slip is employed as the slip 100, the column 202 is not always necessary. If the column 202 is provided, the sender name written in the column 202 may be the name of the shop 2; however, in order to preserve the anonymity of the customer 3 relative to a person in charge of the delivery of an article, i.e., in order not to identify the source of the article purchased by the customer 3, a dummy sender, such as the anonymous service provider 1, may be printed in the column 202. In addition, in order to cope with problems that may arise during delivery, it is also advisable that the anonymous ID of the customer 3 be printed in the column 202.

Before the delivery of an article received from the shop 2, the delivery management system 15, which is the personal information output means, replaces the slip 100 that is attached to the article with a slip 200. To accomplish this, when the article is received, the bar code printed in the bar code column 102 of the slip 100 is scanned using a code reader that serves as the anonymous code input means. Then, the membership DB 13 is examined for the obtained bar code, i.e., the anonymous ID, and a member number corresponding to the anonymous ID is obtained from the ID information table T2. Subsequently, the member information table T1 of the membership DB 13 is examined for the obtained member number, and the name, the address and the telephone number of the corresponding member, i.e., the corresponding customer 3, are obtained. Thereafter, based on the obtained information, the slip 200, on which the personal information for the customer 3 is printed, is prepared and is attached to the article.

This replacement process can be implemented by actually replacing the slip 100 that is attached to the article with the slip 200.

Further, when an electronic chip is included in the slip 100, the information stored on the electronic chip may be exchanged so that the slip 100 can serve as the slip 200.

In this case, until the information on the electronic chip has been replaced, the contents of the slip 100 are displayed when the information stored on the electronic chip is read using the code reader. Thereafter, when the code reader is used to read the electronic chip after the information on it has been replaced, the contents of the slip 200 are displayed.

The information in the code reader that is used to scan the bar code on the slip 100 can also be exchanged by interpretation of the bar code. That is, until the slip 100 is replaced, when the bar code is read using the code reader, the anonymous ID is displayed in the display portion (anonymous code display means) of the code reader. But after the slip 100 is replaced by the slip 200 (the slip 100 is not actually replaced; the data are merely changed by the delivery management system 15), when the bar code on the slip 100 is read using the code reader, the name, the address and the telephone number of the customer 3 are displayed in the display portion (personal information display means) of the code reader, and can be used as the slip 200.

An explanation will now be given, while referring to the system configuration in FIG. 5 and the flowcharts in FIGS. 6 to 9, for the processing performed by the thus arranged system from the time a customer 3 places an order for an article until he or she receives it.

First, FIG. 6 is a flowchart showing the processing that is performed when the customer 3 orders an article from the shop 2. As is shown in FIG. 6, the customer 3, via the network 5, performs in advance a predetermined membership registration process at the anonymous service provider 1, and receives a member number and a password. This membership registration process may be performed immediately before an article is purchased.

As is shown in FIG. 6, to order an article from the shop 2, first, the customer 3 employs the terminal 31 to access the homepage of the shop 2 via the network 5 (step S11). The web server 21 at the shop 2, which is waiting for a user to make a connection, upon being accessed by the customer 3 immediately displays an article screen, an electronic catalog, on the screen of the terminal 31 (step S21).

The customer 3 then selects articles from those shown on the article screen (step S12), and after the selection process has been completed, the shop 2 provides a display listing the articles, and their prices, selected by the customer 3, and requests that he or she confirms the contents of the order (step S22). When the customer 3 has confirmed the contents of the order, he or she clicks on a “buy” button to issue a buy order for the articles from the shop 2 (step S13).

Then, the shop 2 requests that the customer 3 supply payment information for settling the account for the products that were ordered (step S23). In response, the customer 3 designates a payment method and enters predetermined information, such as the type and the amount of electronic money to be remitted (step S14). The shop 2 receives this information (step S24), but since anonymous electronic money is to be employed for the payment, the shop 2 is prevented from obtaining information about the customer 3.

The shop 2 then requests the customer 3 to enter an anonymous ID (step S25). Upon the receipt of this request, the customer 3 activates the number request program 33 (step S15), and requests that the anonymous service provider 1 issue him or her an anonymous ID (step S16).

As is shown in FIG. 7, when the server 11 at the anonymous service provider 1, which is on standby waiting for requests for the issue of anonymous IDs, receives the request from the customer 3, the server 11 requests that the customer 3 enter his or her member number and password (step S31). Then, after the customer 3 has entered his or her member number and password, the server 11 examines the member information table T1 in the membership DB 13 to determine whether the member number and the password are registered. When the member number and password are found in the DB 13, the number generation system 14 generates an anonymous ID (step S32), and examines the ID information table T2 in the membership DB 13 to determine whether the obtained anonymous ID is already in use. When the anonymous ID is not presently in use, it is registered and stored with the correlated member number in the ID information table T2 of the membership DB 13 (step S33). The server 11 at the anonymous service provider 1 then outputs (issues) the thus obtained anonymous ID to the customer 3 (step S34).

As is shown in FIG. 6, when the anonymous ID from the anonymous ID service provider 1 is received by the customer 3 (step S17), he or she supplies the anonymous ID to the shop 2 (step S18). At this time, the anonymous ID may be directly output by the number request program 33 to the shop 2. However, while taking into account the need for improved anonymity, it is preferable that the customer 3 employ the terminal 31 to perform a cut-and-paste or a copy-and-paste procedure for the anonymous ID that is received by the number request program 33, that the anonymous ID be transmitted to the browser 32 using the clip board 34 of the terminal 31 and that it then be output by the browser 32 to the shop 2. By using the clip board 34 for such a transfer, data related to the anonymous ID of the customer 3 can be protected at the worst from theft, while the anonymous ID, issued by the anonymous service provider 1, is being transmitted via the customer 3 to the shop 2.

When the shop 2 receives the anonymous ID from the customer 3, the order receiving/accounting system 22, which serves as the anonymous code reference unit, queries the anonymous service provider 1 to determine whether the anonymous ID is valid (step S26) The anonymous service provider 1 then performs an examination to ascertain whether the anonymous ID is valid, i.e., it examines the ID information table T2 in the membership DB 13 to determine whether the anonymous ID is recorded therein, and transmits the results to the shop 2.

When the anonymous service provider 1 has ascertained that the anonymous ID is valid, the shop 2 requests that the customer 3 perform a final order confirmation.

After the customer 3 has performed a final order confirmation (step S19), the shop 2 requests that the accounting organization 4 remit a payment covering the cost of the articles that the customer 3 ordered (step S27). For this transaction, the shop 2, which is connected to the accounting system 41 at the accounting organization 4 via a VPN (Virtual Private Network) or a dedicated line, outputs to the accounting organization 4 the information concerning the electronic money input by the customer 3 and information concerning the cost of the articles ordered, and requests that the account be settled. The accounting system 41 of the accounting organization 4 examines the electronic money DB 42, and the balance of the electronic money in accordance with the number of the electronic money obtained from the shop 2, and when the balance is sufficient, pays the money charged by the shop 2.

When the transaction between the shop 2 and the accounting organization 4 is successful, the shop 2 stores, in the order DB 26, the contents of the order placed by the customer 3 and the corresponding anonymous ID.

At this time, the order submission processing performed by the customer 3 and the order reception processing performed by the shop 2 are completed. As is described above, when a customer places an order, the shop 2 receives only information (does not include personal information) related to the electronic money used by the customer and the highly anonymous ID. The credit card number of the customer 3, and other personal information, such as name, address and telephone number, are not reported to the shop 2.

An explanation will now be given, while referring to FIG. 8, of the processing performed by the shop 2 from the time it receives the order for the articles from the customer 3 until the articles are dispatched. The flowchart in FIG. 8 differs from the flowcharts in FIGS. 6 and 7, in that whereas the flowcharts in FIGS. 6 and 7 show the processing performed by the web server 21 at the shop 2 and the terminal 31 of the customer 3, the flowchart in FIG. 8 shows the actual, physical processing that is performed.

When the shop 2 receives the order for the articles from the customer 3, the dispatching system 24, which is the slip output unit, examines the order DB 26 and prints a packing manual of the articles (step S41). The packing manual includes a list of the articles ordered and the number of articles. In accordance with the packing manual, the person charged with preparing the order for shipment assembles the articles and packs them. Also, in consonance with the packing manual, the dispatching system 24 prints a slip 100 (step S42). As is shown in FIG. 3, the entries on the slip 100 include only the anonymous ID and the article names; no information concerning the customer 3 is printed.

The slip 100 is then attached to the packed articles (step S43), and they are dispatched to the anonymous service provider 1.

After the anonymous service provider 1 receives the articles from the shop 2, it performs the following processing to deliver them to the customer 3. FIG. 9 is a flowchart showing the processing performed to deliver the articles, which again is not processing performed by a computer, but the actual, physical processing that is performed, as in FIG. 8.

As is shown in FIG. 9, when the anonymous service provider 1 receives the articles from the shop 2, the provider 1 reads the anonymous ID on the slip 100 attached to the articles, and examines the ID information table T2 of the membership DB 13 to determine whether the included anonymous ID is valid (step S51). At this time, when the membership shop number of the shop 2 is printed as the sender on the slip 100, the shop number is input to the server 11. Note, however, that if instead of a machine an operator is charged with reading the slip 100, taking maintenance of anonymity into account, it is preferable that the entry for the sender on the slip not be the name of the shop 2, but that another entry, such as the shop number, be used that does not readily identify the shop 2. The anonymous ID on the slip 100 need not be read at the anonymous service provider 1, but may instead be read when the articles are dispatched from the shop 2. In this case, when a person from the anonymous service provider 1 who is charged with accepting packages for delivery accepts articles at the shop 2, that person will read the anonymous ID on the slip 100. And thus, since the anonymous ID is read at the shop 2, the sender, i.e., the shop 2, need not be printed on the slip 100. Later, after the articles have been delivered to the anonymous service provider 1, since the sender is not printed on the slip 100, it will not be possible for the person in charge at the anonymous service provider 1 to learn the source of the articles.

If, as the result of an examination, it is determined the anonymous ID is valid, the server 11 stores, in the ID information table T2 of the membership DB 13, the processing status of the articles (“received by the anonymous service provider 1”) and the shop number with the correlated anonymous ID.

The delivery management system 15 then issues a delivery slip number for the articles, and stores the slip number with the anonymous ID in the ID information table T2 of the membership DB 13 (step S52). At this time, as needed, a relay slip bearing only the slip number and the anonymous ID may be prepared and attached to the articles instead of the slip 100. As a result, the processing initiated when the anonymous service provider 1 accepted the articles from the shop 2 is terminated.

Under these conditions, even when the anonymous ID on the slip 100 is read by the code reader at the anonymous service provider 1, the member information table T1 of the membership DB 13 can not be examined, and at the hardware level, acquisition of personal information for the customer 3 is impossible.

After the article accepting processing is terminated, the articles are dispatched to an anonymous service provider 1 district collection and delivery center, separate from the location at which the articles were accepted (step S53). The collection delivery center is a division whereat articles collected at various locations are sorted and are dispatched to various destination districts. While again taking anonymity into account, it is preferable that the location whereat accepting processing is performed, and the person charged with its performance, differ from the location of the collection and delivery center, and the person in charge of the dispatch processing, which will be described below.

The anonymous ID on the slip 100 or the relay slip attached to the articles is read, and the delivery management system 15, which is the inquiry means, examines the ID information table T2 of the membership DB 13 and obtains the member number that corresponds to the anonymous ID. Thereafter, the delivery management system 15 examines the member information table T1 to obtain information, including the name, the address and the telephone number of the member (=the customer 3) who corresponds to the member number, and then prepares the slip 200 and prints these data. The slip 100 or the relay slip on the articles is then replaced with the newly prepared slip 200 (step S54).

The articles to which the slip 200 is attached are sorted for dispatch to an area corresponding to the address on the slip 200, i.e., the district collection and delivery center responsible for the area in which the customer 3 is located, and are then delivered to the customer 3 by a delivery man (step S55). As a result, the customer 3 receives the articles ordered to the shop 2.

When the delivery has been completed, the delivery man inputs, to the delivery management system 15, the bar code in the bar code column 203 of the slip 200 (step S56). The delivery management system 15 then obtains the slip number included in the bar code, and employs the slip number to examine the ID information table T2 of the membership DB 13. Thereafter, the delivery management system 15 records, in the ID information table T2, data to the effect that the anonymous ID corresponding to the slip number has been used, and deletes the anonymous ID from the ID information table T2, as needed, at that time or after a predetermined period of time has elapsed. In addition, the delivery management system 15 stores, in the delivery DB 16, the article delivery record with the corresponding slip number.

The anonymous ID that is deleted from the ID information table T2 can also be re-used for another article transaction.

As is described above, in the online shopping system of this embodiment, the customer 3 employs the anonymous ID to order articles from the shop 2, and the slip 100, on which no personal information for the customer 3 is printed, is employed when the shop 2 dispatches the articles to the anonymous service provider 1. There, the slip 100 is replaced with the slip 200 on which the name and the address of the customer 3 are printed, and thereafter, the articles, bearing the slip 200, are delivered to the customer 3. Therefore, as is shown in FIG. 10, the only information concerning the customer 3 that can be acquired by the shop 2 is “from where (shop 2)” and “what (articles) is bought”; the acquisition of “who” is prevented. The anonymous service provider 1 acquires only “who (customer 3)” and “from where (shop 2)”, and can obtain no information about “what” was bought at the shop 2. In this manner, anonymity for the customer 3 can be enhanced. In addition, when a relay slip is employed by the anonymous service provider 1 to effect the change from the slip 100 to the slip 200, the person in charge can be prevented from employing both the slips 100 and 200 to obtain information concerning “where” the customer 3 bought the articles.

When a customer 3 does not receive an article or an article is damaged or malfunctions, he or she can notify the anonymous service provider 1 or can return the article, and the anonymous service provider 1 can enter into negotiations with the shop 2 for the customer 3.

Second to fifth embodiments will now be described as modifications of the first embodiment. Since the basic system configuration for each embodiment is the same as that shown in FIG. 1, only those portions that are different will be described, and no explanation will be given for the configuration and the transaction processing that are used in common.

### Second Embodiment

FIG. 11 is a diagram for explaining an online shopping system according to a second embodiment of the invention. The system configuration in FIG. 11 is the same as that in FIG. 1, with the exception that the number request program 33 is not employed by the customer 3 but by the shop 2. To purchase goods from the shop 2 via the network 5, the customer 3 orders an article from the shop, pays the price for the article using electronic money, and designates a delivery method. The designation of the delivery method means that goods from the shop 2 are delivered via the anonymous service provider 1 to the customer 3 (\mathring{1}) in FIG. 11) using an anonymous ID.

Then, the shop 2 uses the number request program 33 to request that the anonymous service provider 1 issue an anonymous ID (\mathring{2}), and receives an anonymous ID that is issued by the number generation system 14 of the anonymous service provider 1 (\mathring{3}). At this time, the anonymous service provider 1 merely issues the anonymous ID, and does not store data correlated with information for the customer 3.

Following this, the shop 2 notifies the customer 3 via the network 5 of the received anonymous ID (\mathring{4}). The customer 3 then accesses the anonymous service provider 1, via the network 5, and supplies a member number and a password, which have been registered in advance, and the anonymous ID received from the shop 2, and registers the anonymous ID (\mathring{5}). Upon the receipt of this data, the anonymous service provider 1 examines the member information table T1 of the membership DB 13 to verify the member number and the password, and stores the anonymous ID and the member number in the ID Information table T2.

Thereafter, the shop 2 attaches a slip 100 bearing the anonymous ID to the article that was ordered by the customer 3, and dispatches the article to the anonymous service provider 1 (\mathring{6}). Subsequently, as in the first embodiment, the anonymous service provider 1 replaces the slip 100 with a slip 200 (\mathring{7}), and delivers the article to the customer 3 (\mathring{8}).

### Third Embodiment

FIG. 12 is a diagram for explaining an online shopping system according to a third embodiment of the invention. In the example in FIG. 12, before ordering an article from the shop 2, the customer 3 requests that the anonymous service provider 1 issue an anonymous ID (\mathring{1}), and receives the anonymous ID from the anonymous service provider 1 in the same manner as in the first embodiment (\mathring{2}).

Then the customer 3 orders the article and pays the price charged by the shop 2. At this time, the customer 3 notifies the shop 2 of the anonymous ID (\mathring{3}).

Following this, as in the first embodiment, the shop 2 queries the anonymous service provider 1 to determine whether the anonymous ID is valid (\mathring{4}), and its validity is confirmed (\mathring{5}). Thereafter, the shop 2 attaches a slip 100 bearing the anonymous ID to the article that was ordered by the customer 3, and dispatches the article to the anonymous service provider 1 (\mathring{6}). Subsequently, the anonymous service provider 1 replaces the slip 100 on the article with a slip 200 (\mathring{7}), and delivers the article to the customer 3 (\mathring{8}).

### Fourth Embodiment

FIG. 13 is a diagram for explaining an online shopping system according to a fourth embodiment. In the example in FIG. 13, before ordering an article from the shop 2, the customer 3 issues an anonymous ID (\mathring{1}). At this time, the customer 3 prepares an arbitrary ID or employs a program provided by the anonymous service provider 1 to generate a random alphanumeric sequence to obtain an anonymous ID.

The customer 3 accesses the anonymous service provider 1 via the network 5 to request the registration of the anonymous ID (\mathring{2}). Upon the receipt of this request, the anonymous service provider 1 examines the ID information table T2 of the membership DB 13 to determine whether that anonymous ID is already registered. If the anonymous ID is already registered in the table T2, the anonymous service provider 1 requests that the customer 3 supply a new anonymous ID. If the anonymous ID is not present, the anonymous service provider 1 stores the anonymous ID with the member number of the customer 3 in the ID information table T2.

Then, the customer 3 orders an article and pays the price charged by the shop 2. At this time, the customer 3 supplies the anonymous ID to the shop 2 (\mathring{3}).

Following this, as in the first embodiment, the shop 2 queries the anonymous service provider 1 to determine whether the anonymous ID is valid (\mathring{4}), and it validity is confirmed (\mathring{5}). Thereafter, the shop 2 attaches a slip 100 bearing the anonymous ID to the article that was ordered by the customer 3, and dispatches the article to the anonymous service provider 1 (\mathring{6}). The anonymous service provider 1 replaces the slip 100 on the article with a slip 200 (\mathring{7}), and delivers the article to the customer 3 (\mathring{8}).

### Fifth Embodiment

FIG. 14 is a diagram for explaining an online shopping system according to a fifth embodiment. In the example in FIG. 14, the customer 3 employs the anonymous service provider 1 to pay the shop 2 the price charged for an article.

Specifically, the customer 3 obtains the proof of his or her solvency from the service provider 1 through, for example, prepayment of electronic money, registration of credit card information, and examination of creditability. When solvency can not be confirmed, the customer 3 may prepay a certain amount of money to the anonymous service provider 1 (\mathring{1}). The solvency information or the prepaid money information for the customer 3 is stored with the corresponding member number of the customer 3 in the member information table T1 of the membership DB 13.

To purchase an article from the shop 2, the customer 3 requests that the anonymous service provider 1 initiate the purchase process (\mathring{2}). Then, the anonymous service provider 1 issues an anonymous ID to the customer 3 in the same manner as in the first embodiment (\mathring{3}).

Thereafter, the customer 3 orders an article and supplies the anonymous ID to the shop 2 (\mathring{4}).

Then, the shop 2 notifies the anonymous service provider 1 of the anonymous ID, and asks that a credit check be performed for it (\mathring{5}). The anonymous service provider 1 employs the solvency confirmation system (not shown) to examine the ID information table T2 and obtain the member number corresponding to the anonymous ID. Then, the solvency service system refers to the solvency information or to the prepaid money information for the customer 3 in the member information table T1, and transmits the results obtained to the shop 2. If the results are satisfactory, the shop 2 attaches a slip 100 bearing the anonymous ID to the article, and dispatches the article to the anonymous service provider 1 (\mathring{6}). Upon the receipt of the article, the anonymous service provider 1 permits the payment proxy system (not shown) to pay the shop 2 the price charged for the article (\mathring{7}). Thereafter, if the customer 3 uses a credit card, it is possible that the anonymous service provider 1, which paid the price charged by the shop 2, contacts the credit card company that issued the credit card used by the customer 3 to recover the money it paid during the purchase transaction. The customer 3 may also employ a credit card issued by the anonymous service provider 1.

The anonymous service provider 1 replaces the slip 100, attached to the article received from the shop 2, with a slip 200 (\mathring{8}), and delivers the article to the customer 3 (\mathring{9}). It is possible to deliver the article to the customer 3 before the payment of the price charged by the shop 2 (\mathring{7}).

With this arrangement, when the customer 3 uses a credit card for make a payment to the shop 2, the information concerning the credit card is not reported to the shop 2, and the anonymity of the customer 3 is ensured.

As is described in the above embodiments, whether the name of the shop 2 is to be written on a slip 100, and whether a relay slip is to be used when changing from a slip 100 to a slip 200 depends on the level of the anonymity that is to be ensured by the online shopping system. When a relay slip is attached to an article at step S54 for the slip replacement procedure, no information concerning the source (shop 2) of the article is provided for the person charged with the slip replacement, and this is especially preferable because the provision of anonymity is absolutely ensured.

Further, in some cases, when changing from a slip 100 to a slip 200, no particular problem occurs even when the membership number of the shop 2 is printed on a slip 100 attached to an article. In addition, there are cases where articles can not be identified by name in the article name column 103, or cases where, even when articles can be identified, it is not a matter that affects the acquisition of anonymity. In these cases, relay slips are not necessarily employed.

While taking into account the subject of the embodiments for the acquisition of anonymity, it is preferable that an anonymous ID be effective only for one transaction. However, it is possible to use the anonymous ID for a plurality of transactions during a predetermined period of time.

Furthermore, for example, when the shop 2 dispatches an article to the anonymous service provider 1, the addressee may be the anonymous service provider 1 and the sender may be the shop 2. Thus, since for the shop 2, the addressee for all articles is the anonymous service provider 1, the anonymity that is provided can be improved. With this arrangement, the anonymous service provider 1 is not necessarily the party that handles the delivery of an article, and may merely be a party that has a tie-in with the delivery party. That is, the anonymous service provider 1 may only issue an anonymous ID and replace a slip 100 with a slip 200.

In the systems described above, transactions using anonymous IDs are not always employed for all customers 3. As in the conventional case, payment using a credit card may be employed for a customer 3 who does not care about anonymity, and the shop 2 may employ the personal information supplied by the customer 3, such as name, address and telephone number, to directly deliver an article to the customer 3. That is, in this case, the anonymous service provider 1 and the shop 2 provides the above described system only for those customers 3 who desire the service.

In addition, in the above described embodiments, the shop 2 inquires as to the validity of an anonymous ID before dispatching an article, and in this fashion is able to eliminate an invalid order. This is merely an optional and additional process, and is not a requisite provision for the individual embodiments of the invention. When the shop 2 inquires as to the validity of an anonymous ID before dispatching an article, the anonymous service provider 1 may not only confirm the validity of the anonymous ID, but may also correlate the anonymous ID with the shop number of the shop 2 and store the data. Thus, the article and the sender can be correlated with each other without the name of the sender being printed on the slip 100.

Moreover, a case where the customer 3 purchases an article is assumed in the above embodiments. The present invention can also be effectively applied for a case wherein an article is free, i.e., where the article is merely delivered in accordance with the order.

Furthermore, to permit the computers for the anonymous service provider 1, the shop 2 and the customer 3 to perform the above program, the present invention may be a storage medium, such as a CD-ROM, a DVD, various types of portable memory or a hard disk, on which the above program is stored. The present invention may also be a program transmission apparatus that comprises storage means, such as a CD-ROM, a DVD, a portable memory or a hard disk, on which the above program is stored; and transmission means for reading the program and transmitting it directly or indirectly to an apparatus whereat it is executed.

### Advantages of the Invention

As is described above, according to the present invention, the anonymity of a customer can be enhanced, so that the customer can shop on line while maintaining his or her anonymity.

### BRIEF DESCRIPTION OF THE DRAWINGS

FIG. 1 is a diagram illustrating the configuration of an online shopping system according to a first embodiment.

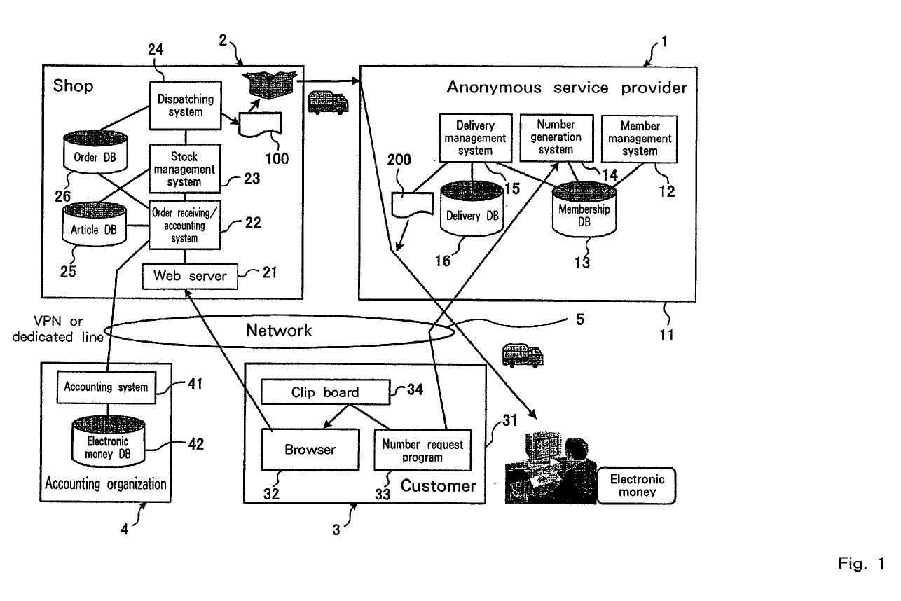

FIGS. 2A and 2B are diagrams showing a member information table and an ID information table held by a service provider.

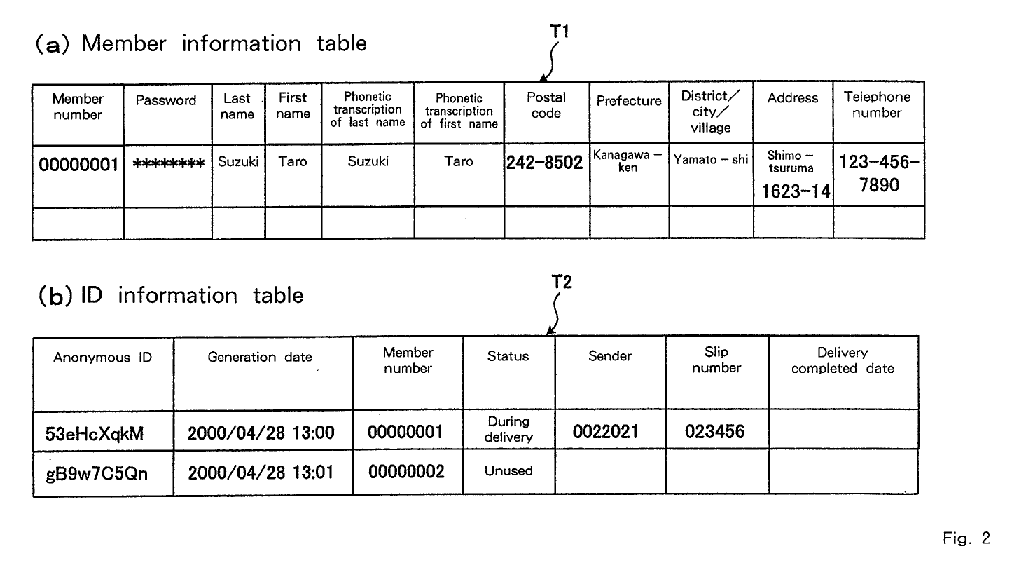

FIG. 3 is a diagram showing an example slip used by a shop for dispatching an article.

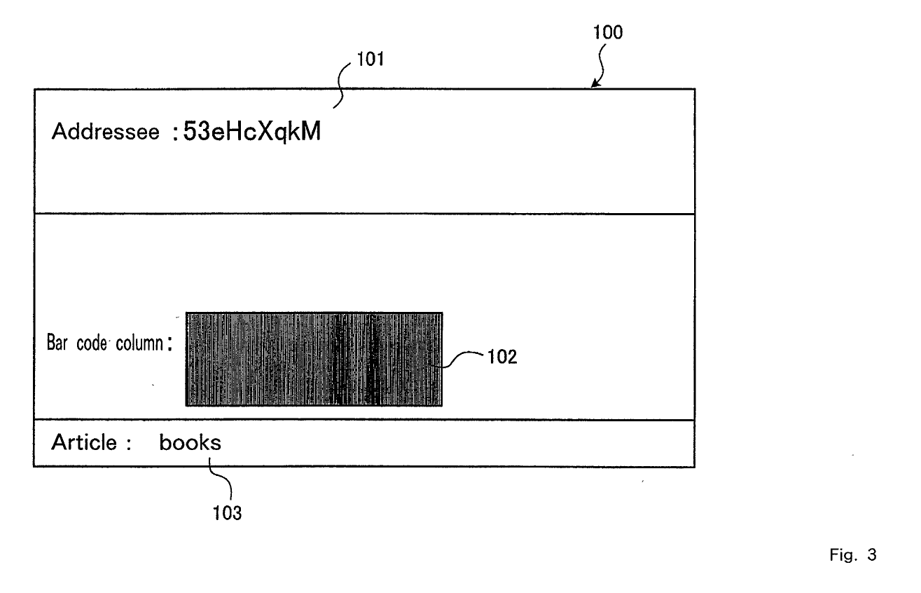

FIG. 4 is a diagram showing an example slip used by the service provider for delivering an article.

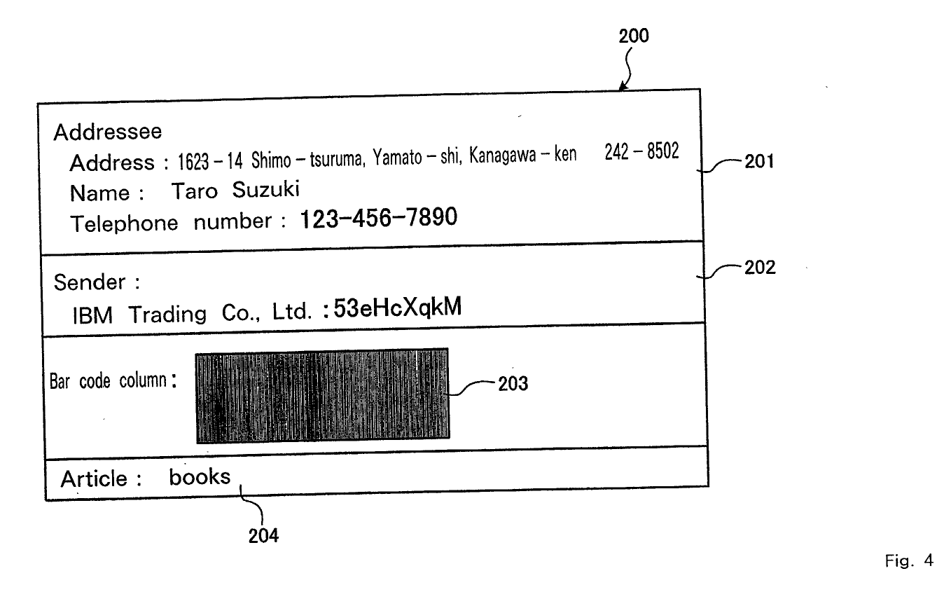

FIG. 5 is a diagram showing online shopping.

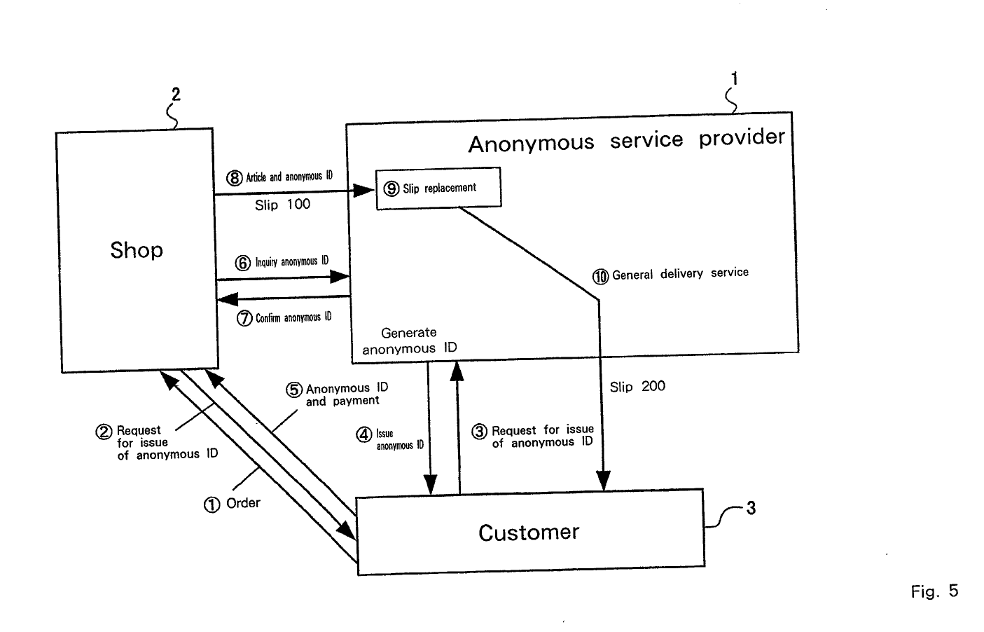

FIG. 6 is a flowchart showing the order processing performed between a customer and a shop.

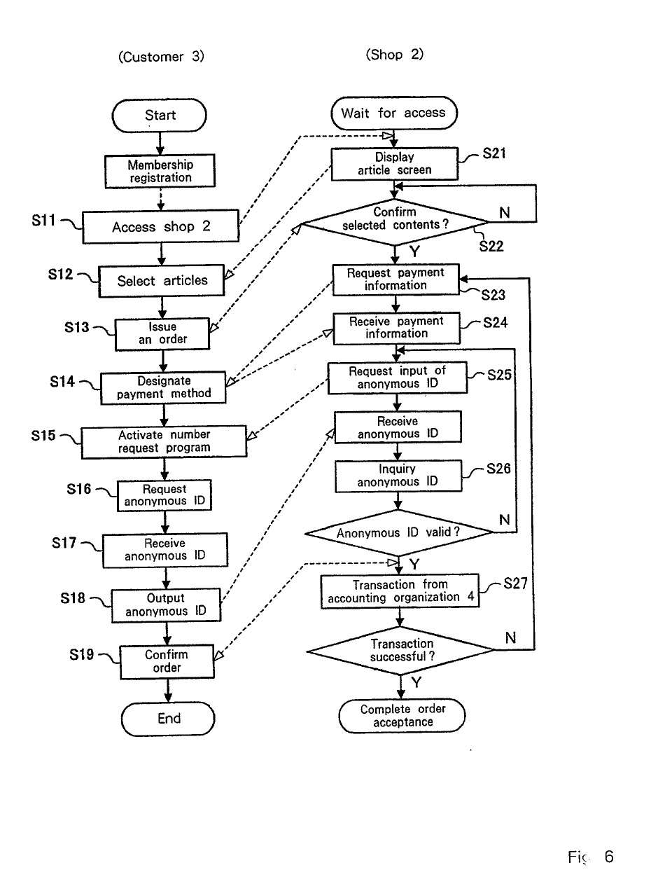

FIG. 7 is a flowchart showing the anonymous ID issuing processing.

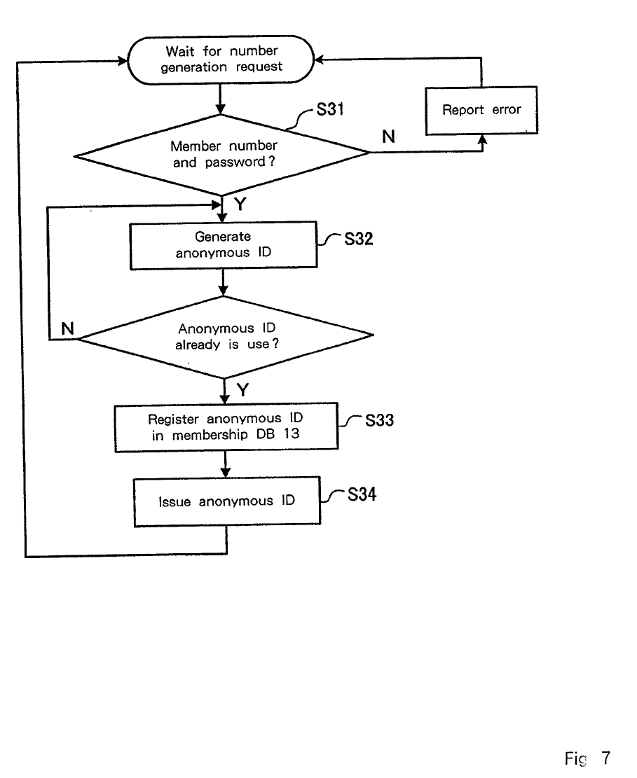

FIG. 8 is a flowchart showing the processing performed by a shop from the time an order for an article is received until the article is dispatched.

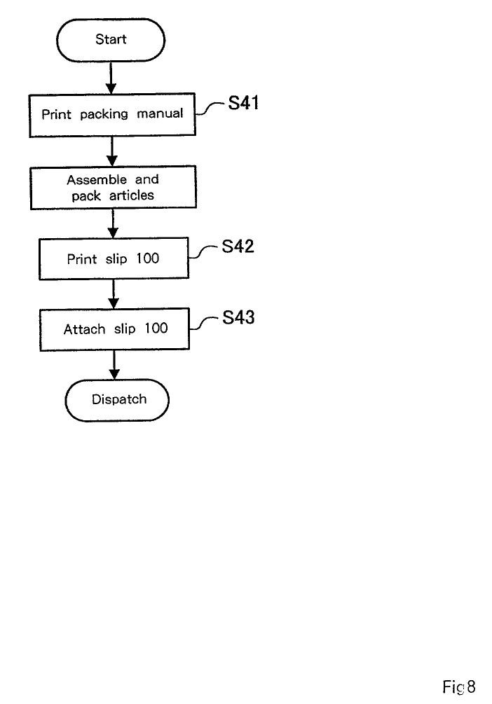

FIG. 9 is a flowchart showing the processing performed by the service provider.

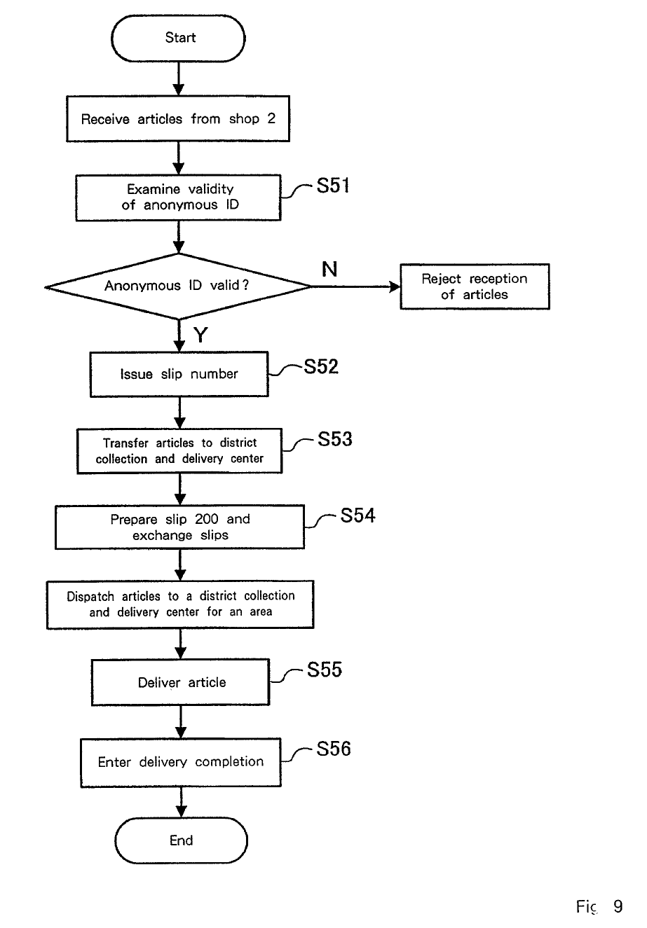

FIG. 10 is a table showing information that the shop, the service provider, an accounting organization and a customer can obtain.

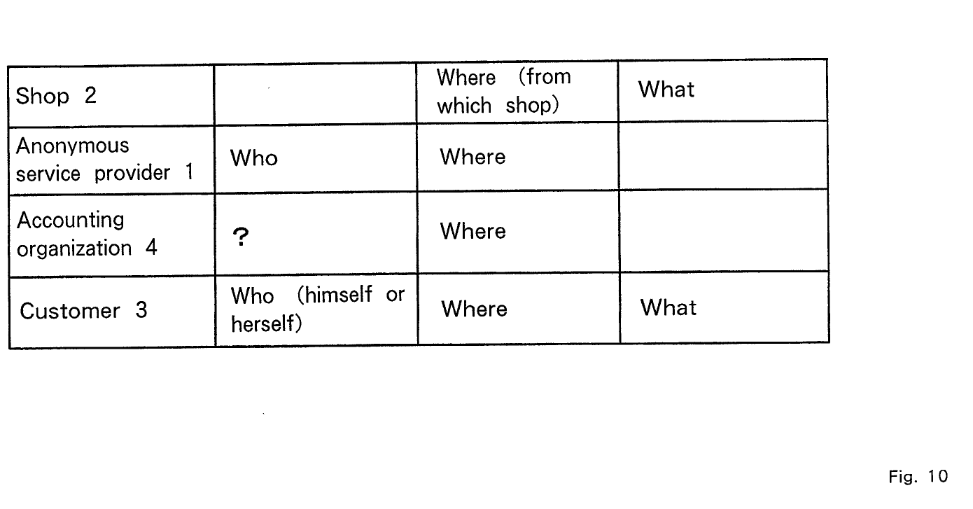

FIG. 11 is a diagram showing online shopping according to a second embodiment.

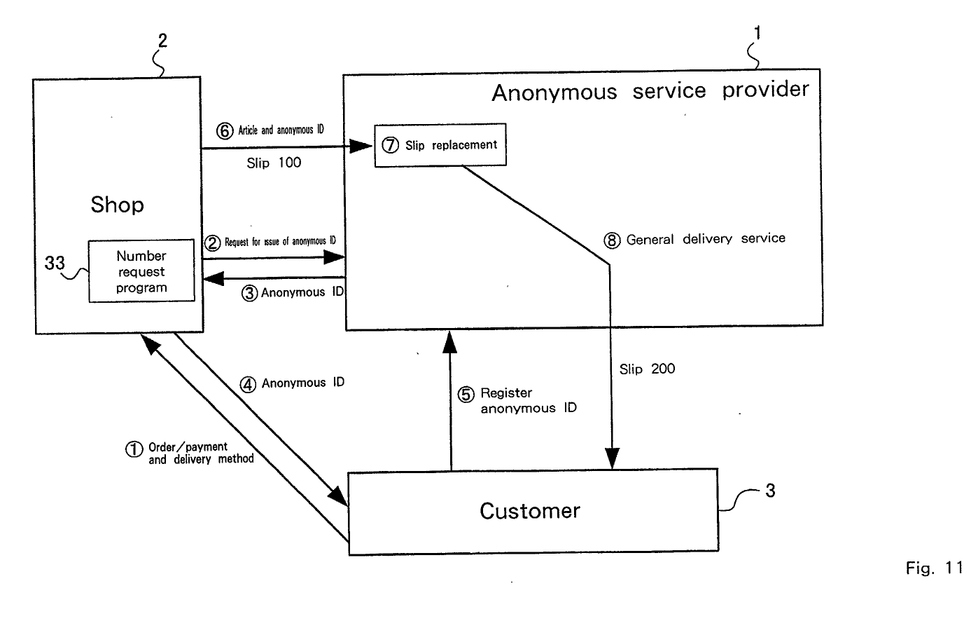

FIG. 12 is a diagram showing online shopping according to a third embodiment.

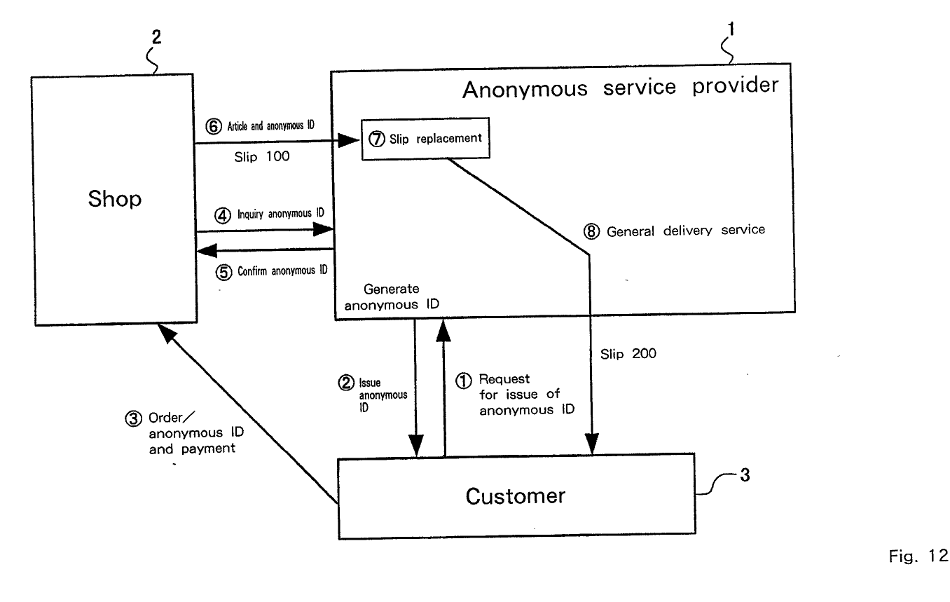

FIG. 13 is a diagram showing online shopping according to a fourth embodiment.

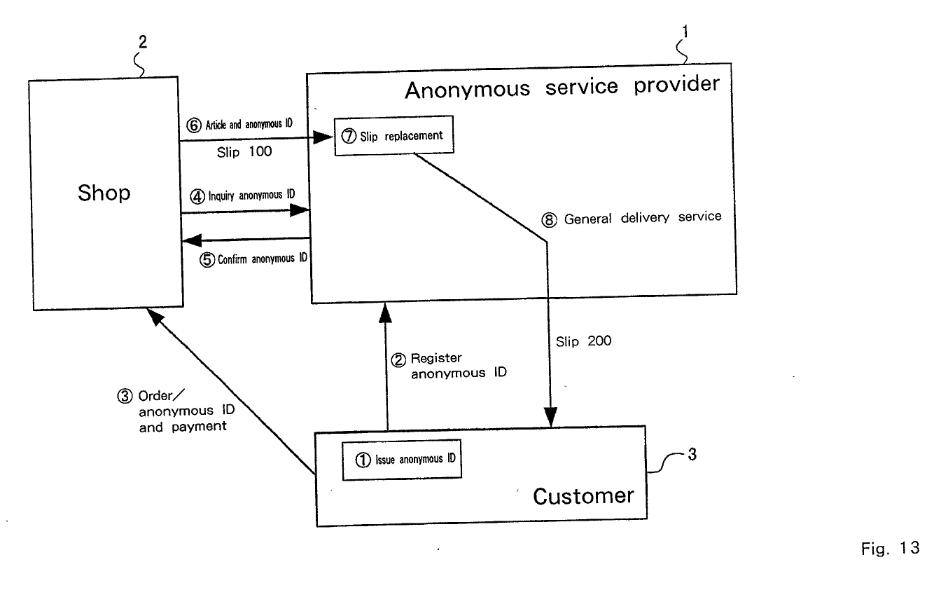

FIG. 14 is a diagram showing online shopping according to a fifth embodiment.

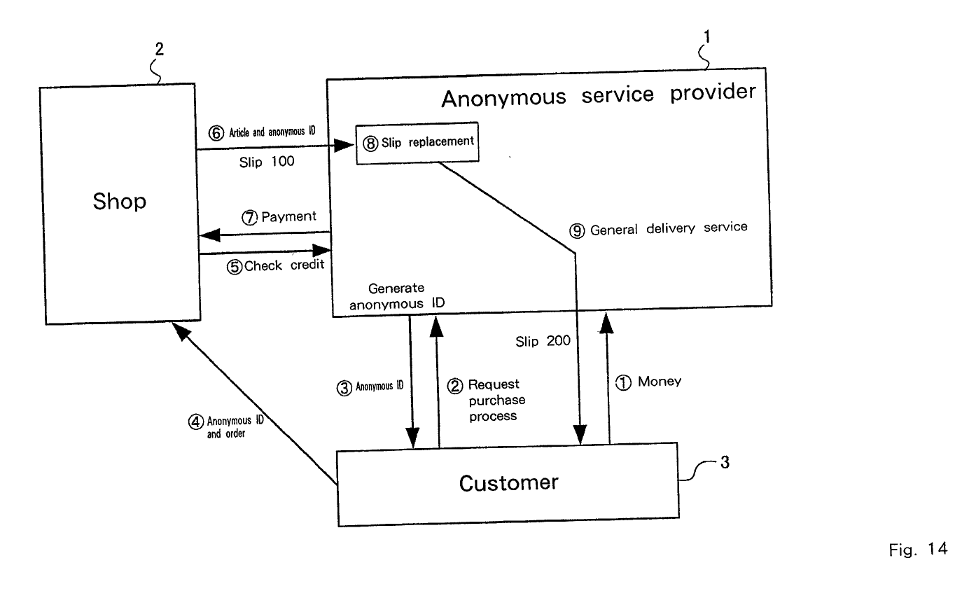

### DESCRIPTION OF THE SYMBOLS

1: Anonymous service provider (service provider, third party)

2: Membership shop (shop)

3: Customer

4: Accounting organization

5: Network

11: Server

13: Membership DB (information storage means)

14: Number generation system (code generation means)

15: Delivery management system (personal information output means)

21: Web server

22: Order receiving/accounting system (order acceptance unit, anonymous code inquiry unit)

24: Dispatching system (slip output unit)

31: Terminal

32: Browser

33: Number request program

34: Clip board

100: Slip (first slip)

200: Slip (second slip, delivery slip)

T1: Member information table

T2: ID information table

1. A goods delivery method, whereby an article ordered by a customer via a network is delivered to the customer by a service provider, comprising the steps of:
(a) the shop obtaining article information that specifies the article to be delivered to the customer and an anonymous code that specifies the delivery address of the customer;
(b) the shop transmitting, to the service provider, the article that corresponds to the article information so as to correlate anonymous code with the article;
(c) the service provider obtaining the delivery address for the customer based on the anonymous code; and
(d) the service provider delivering the article to the customer based on the delivery address obtained at the step (c).

2. A goods delivery method, whereby an article ordered by a customer via a network is delivered to the customer by a service provider, comprising the steps of:
(a) from a shop that obtains article information for specifying an article to be delivered to the customer and anonymous code for specifying a delivery address for the customer, receiving an article that corresponds to the article information correlated with the anonymous code;
(b) employing the anonymous code to obtain the delivery distribution for the customer; and
(c) transporting the article to the customer based on the delivery address obtained at the step (b).

3. The goods delivery method according to claim 2, wherein, upon receipt of a request from the customer, the anonymous code is issued by the service provider via the network.

4. The goods delivery method according to claim 2, wherein the anonymous code is issued by the customer, and is stored by the service provider correlated with delivery address information for the customer.

5. The goods delivery method according to claim 2, wherein, upon receipt of a request from the shop, the anonymous code is issued to the shop by the service provider via the network, and wherein the anonymous code is transmitted by the shop to the customer via the network.

6. The goods delivery method according to claim 2, wherein the service provider attaches, to the article, a delivery slip on which the delivery address is printed, and delivers the article to the customer.

7. The goods delivery method according to claim 2, wherein the service provider pays the shop the price charged for the article.

8. An online shopping method, employed between a shop for an article and a customer of the article via a network, comprising the steps of:
a server at the shop receiving, via the network, an order for an article from the customer and anonymous code that is supplied; and
the shop transferring the article to a third party that holds the anonymous code information and personal information for the customer, and that delivers the article to the customer based on the personal information.

9. The online shopping method according to claim 8, wherein the personal information includes the name and address of the customer.

10. The online shopping method according to claim 8, wherein the customer employs electronic money to pay the shop for the article via the network.

11. An online shopping system, whereby a customer issues an order to a shop via a network, comprising:
a server for the shop;
a terminal for the customer; and
a server for a service provider, connected to the network, for storing personal information for the customer correlated with an anonymous code provided for the customer,
wherein the customer employs the terminal to issue an order for an article and to supply the anonymous code to the server for the shop,
wherein the shop attaches the anonymous code to the article that is ordered, and transfers the article to the service provider, and
wherein the service provider employs the server for the service provider to output the personal information for the customer that is correlated with the anonymous code attached to the article, and to attach the personal information to the article and transport the article to the customer.

12. The online shopping system according to claim 11, wherein the shop employs the server for the shop to output a first slip on which the anonymous code is printed, and to transfer to the service provider the article with the first slip attached thereto; and
wherein the service provider employs the server for the service provider to output a second slip on which the personal information for the customer is printed, and to replace the first slip on the article with the second slip and transport the article to the customer.

13. A server comprises:
information storage means for an anonymous code, which is used as information for a customer when the customer purchases an article from a shop, correlated with delivery address information for the customer;
anonymous code input means for, upon the receipt of an article to which an anonymous code is attached, printing the anonymous code; and
delivery address information output means for examining the information storage means to output the delivery address information for the customer that is correlated with the anonymous code.

14. The server according to claim 13, further comprising:
code generation means for generating the anonymous code upon the receipt of a remotely sourced request.

15. The server according to claim 13, wherein the information storage means deletes the anonymous code when a predetermined period of time has elapsed.

16. The server according to claim 13, wherein the information storage means deletes the anonymous code when the anonymous code has been used once.

17. The server according to claim 13, further comprising:
solvency confirmation means for confirming the solvency of the customer; and
payment proxy means for paying a price charged for the article to the shop when the solvency of the customer is confirmed by the solvency confirmation means.

18. A server for a shop, which delivers an article that is ordered by a customer who supplied an anonymous code, to the customer via a third party that manages the anonymous code and personal information for the customer, comprising:
an order acceptance unit for accepting an order from the customer via a network;
an anonymous code inquiry unit for querying the third party via the network concerning the anonymous code supplied by the customer; and
a slip output unit for, when the anonymous code inquiry unit obtains a conformation for the anonymous code from the third party, printing the anonymous code on a slip to be attached to the article and outputting the slip.
